(19) United States
(12) Patent Application Publication
(10) Pub. No.: US 2007/0211265 A1
(43) Pub. Date: Sep. 13, 2007

(54) Print Control System, Print Control Method, Print Control Program Storage Medium, And Printing System

(75) Inventor: Shusuke Tanimoto, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/611,224

(22) Filed: Dec. 15, 2006

(30) Foreign Application Priority Data
Mar. 7, 2006 (JP) 2006-060924

(51) Int. Cl. G06K 15/02

(52) U.S. Cl. 358/1.2; 358/1.9

(57) ABSTRACT

There is provided a print control system including a receiving unit that receives from a client a print request relating to saved document data, an acquisition unit that acquires print set data which specify whether respective pages of the document data are to be printed in color or in monochrome and a print instruction unit that causes a printer to print the document data on the basis of the print set data, wherein the print set data are data that are saved in advance in association with the document data.

### PRIORITY INFORMATION

This application claims priority from Japanese Patent Application No. 2006-60924, filed on Mar. 7, 2006.

### BACKGROUND

1. Technical Field

The present invention relates to a technology relating to control of a printing job and, more specifically, to a technology for performing print setting for each page.

2. Related Art

In a printing job, if an attribute which affects the mode of the printing process is known before the start of a developing process of each page, the efficiency of the printing process or the image quality can be improved.

### SUMMARY

According to an aspect of the invention, there is provided a print control system including a receiving unit that receives from a client print requests relating to saved document data, an acquisition unit that acquires print set data which indicate whether respective pages of the document data are to be printed in color or in monochrome, and a print instruction unit that causes a printer to print the document data on the basis of the print set data, wherein the print set data are data that are saved in advance in association with the document data.

### BRIEF DESCRIPTION OF THE DRAWINGS

Exemplary embodiments of the present invention will be described by reference to the following figures, wherein:

FIG. 1 is a block diagram for explaining a general configuration of a printing system according to a first exemplary embodiment;

FIG. 2 is a flowchart for explaining a flow of a process for registering and updating;

FIG. 3 is a flowchart for explaining a flow of a process at the time of printing;

FIG. 4 is a flowchart for explaining a process when a load of a document control server is low;

is FIG. 5 is a block diagram for explaining a general configuration of the printing system according to a second exemplary embodiment;

FIG. 6 is a flowchart for explaining a process at the time of updating;

FIG. 7 is a flowchart for explaining a flow of a process at the time of printing;

FIG. 8 is a flowchart for explaining a process when the load of the document control server is low; and

FIG. 9 is a block diagram for explaining a general configuration of the printing system according to a third exemplary embodiment.

### DETAILED DESCRIPTION

### First Exemplary Embodiment

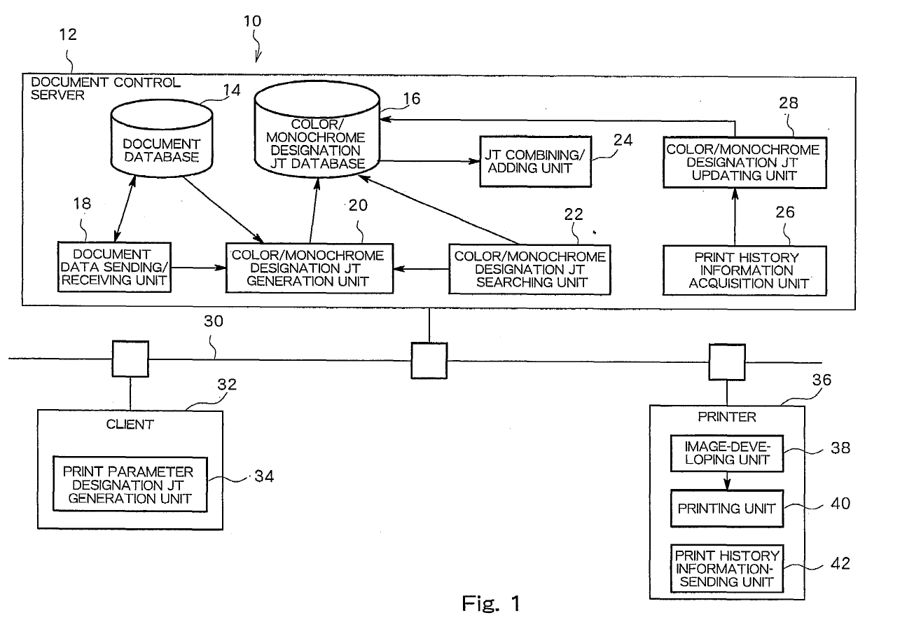

FIG. 1 is a block diagram showing a general configuration of a printing system 10 according to a first exemplary embodiment. The printing system 10 mainly includes a document control server 12, a client 32, and a printer 36, and these members are connected by a network 30 so as to be in mutual communication.

The document control server 12 includes a function for generating and controlling document data used for printing a job or data relating to print setting thereof, as well as a function as a print control system that receives a print request for the document data and issues a print instruction to the printer. The document control server 12 is provided with a document database 14, a color/monochrome designation JT database 16, a document data sending/receiving unit 18, a color/monochrome designation JT generation unit 20, a color/monochrome designation JT searching unit 22, a JT combining/adding unit 24, a print history information acquisition unit 26, and a color/monochrome designation JT updating unit 28.

The document database 14 is a database in which the document data to be printed are saved. The color/monochrome designation JT database 16 is a database in which a color/monochrome designation JT (job ticket) is saved. The color/monochrome designation JT is data which are associated with the document data, in which print set data designating whether respective pages of the corresponding document data are to be printed in color or in monochrome are written in the format of a control parameter of the job ticket.

The document data sending/receiving unit 18 receives the document data from the client 32 or the like and registers the same in the document database 14, or sends the document data registered in the document database 14 to the printer 36 when issuing the print instruction. The color/monochrome designation JT generating unit 20 analyzes the document data saved in the document database 14, and generates the color/monochrome designation JT in which the color/monochrome print-setting for each page is stated. The color/monochrome designation JT generation unit 20 also saves the generated color/monochrome designation JT in the color/monochrome designation JT database 16 in association with the document data.

The color/monochrome designation JT searching unit 22 searches for a color/monochrome designation JT corresponding to the document data from the color/monochrome designation JT database 16. The JT combining/adding unit 24 combines the color/monochrome designation JT and the print parameter designation JT received upon issuance of the print request to generate a JT for actually issuing an instruction to the printer 36. Then, the print history information acquisition unit 26 receives print history information from the printer 36 after printing of the job, and the color/monochrome designation JT updating unit 28 compares the print history information with the JT relating to the print instruction to thereby update the color/monochrome designation JT as needed.

The client 32 is a device constructed from a PC or the like, and is used as a terminal used by a user for specifying the document data. The client 32 is provided with a print parameter designation JT generation unit 34. The print parameter designation JT generation unit 34 generates the print parameter designation JT in which settings of various print parameters such as double-side printing, Nup, the number copies of printing, and so on are stated on the basis of instructions from the user. The print parameter designation JT is sent to the document control server 12 together with information on the location of the document data.

The printer 36 is a device for actually performing the printing job on the basis of the instruction from the document control server 12, and is a single printer or a multi-function machine having a printing function. The printer 36 is provided with an image-developing unit 38, a printing unit 40, and a print history information-sending unit 42. The image-developing unit 38 develops the document data on the basis of the JT, and generates image data. The printing unit 40 performs color printing or monochrome printing on the basis of the JT for the print data. Then, the print history information-sending unit 42 analyzes the print data and sends to the document control server 12 the print history information indicating whether each page is actually printed in color or in monochrome.

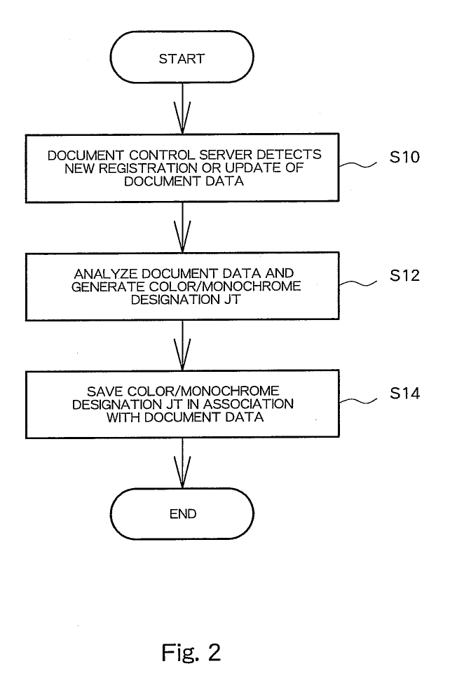

Subsequently, by reference to flowcharts in FIG. 2 to FIG. 4, the operation of the printing system 10 shown in FIG. 1 will be described.

FIG. 2 is an explanatory drawing illustrating a process in a case where new document data are registered in the document control server 12 or where the document data already saved are updated. Here, the document data sending/receiving unit 18 registers (saves) new document data to the document database 14 or updates the document data saved therein, and issues an instruction to generate a JT to the color/monochrome designation JT generation unit 20 (S10). Then, the color/monochrome designation JT generation unit 20 acquires the corresponding document data from the document database 14, analyzes the same, and generates a color/monochrome designation JT on the basis of the result of analysis (S12) Then, the color/monochrome designation JT generation unit 20 saves the generated color/monochrome designation JT in the color/monochrome designation JT database in association with the document data (S14).

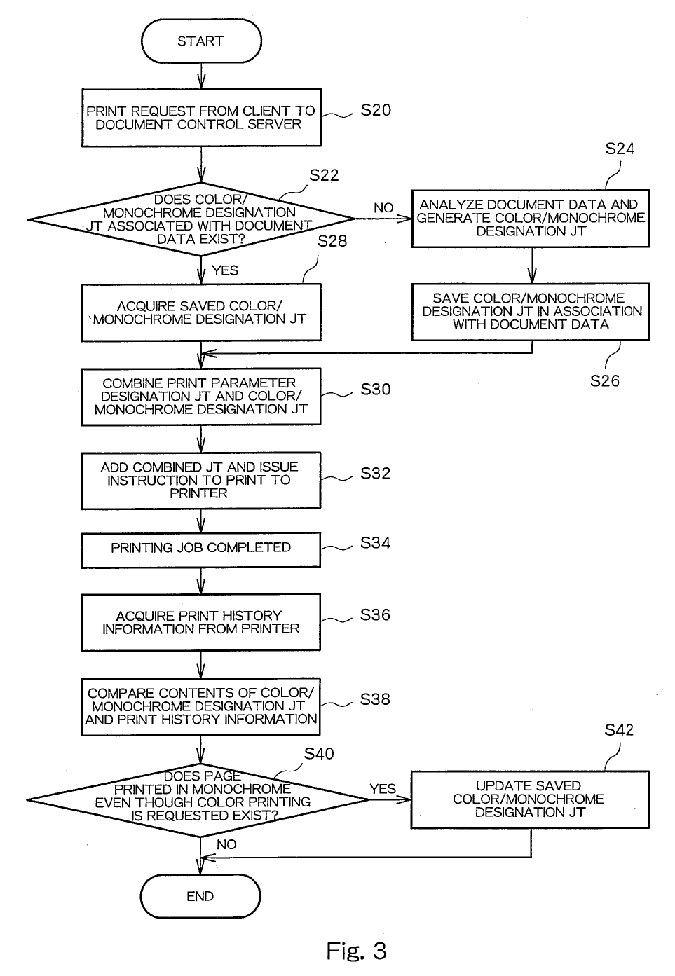

FIG. 3 is a flowchart for explaining a flow of a process in a case where a print request is issued from the client 32 to the document control server 12. In the client 32, the print parameter designation JT is generated in the print parameter designation JT generation unit 34. Then, the client 32 sends the print parameter designation JT to the document control server 12 together with information on the location of the saved document data to thereby issue a print request (S20). In the document control server 12, the color/monochrome designation JT searching unit 22 searches the color/monochrome designation JT database 16, and determines whether or not the color/monochrome designation JT associated with the document data exists (S22). If it does not exist, the color/monochrome designation JT generation unit 20 generates a color/monochrome designation JT (S24) and saves the same in the color/monochrome designation JT database 16 in association with the document data (S26), and sends the same to the JT combining/adding unit 24. In contrast, if it does exist, the JT combining/adding unit 24 acquires the existing color/monochrome designation JT (S28) In the JT combining/adding unit 24, the color/monochrome designation JT is combined with the print parameter designation JT sent from the client 32 (S30). Then, the combined JT is transmitted to the printer 36 together with the document data, and the print instruction is issued (S32).

In the printer 36, the image-developing unit 38 develops the received document data on the basis of the JT and generates the print data, and the printing unit 40 prints the print data. In other words, the printer 36 sets the print mode to either the color printing or the monochrome printing for each page in accordance with the JT, and performs the printing job. Then, the print history information sending unit 42 generates the print history information which specifies whether or not each page is printed in color, on the basis of the print data, and sends it to the document control server 12.

In the document control server 12, the print history information acquisition unit 26 receives the print history information (S36), and the color/monochrome designation JT updating unit 28 compares the combined JT and the print history information (S38). Then, when the page which is requested to be printed in color by the JT is actually printed in monochrome (S40), the saved color/monochrome designation JT is updated, and the instruction for the page in question is corrected to monochrome (S42). Accordingly, for example, when the color image does not appear because objects are overlapped, the page in question is set to the monochrome printing.

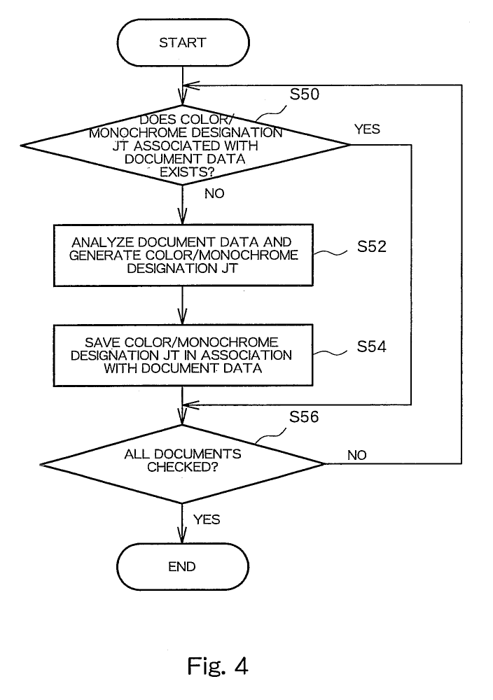

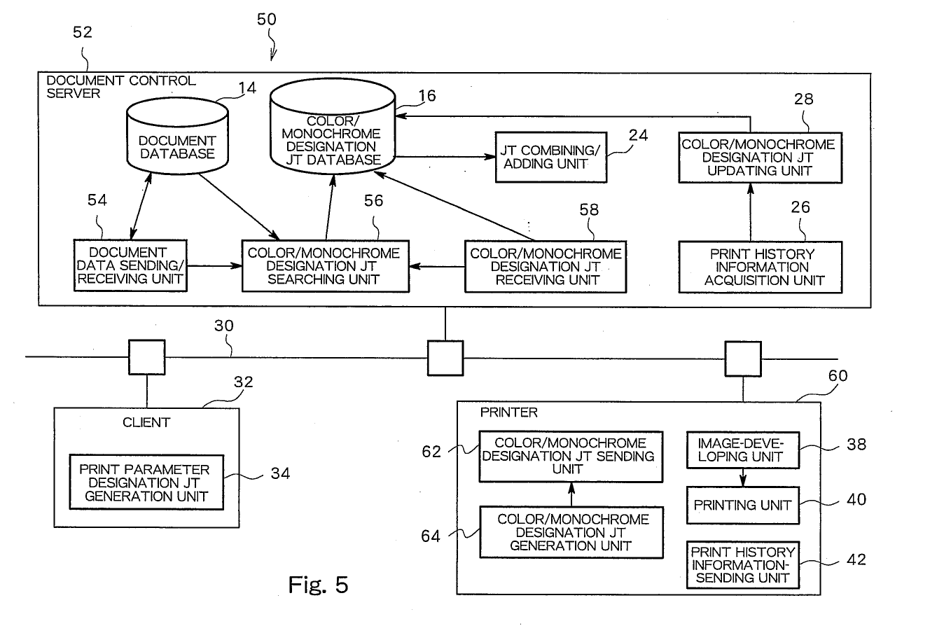

FIG. 4 is a flowchart for explaining an operation performed in the document control server 12 when there is computational power to spare. When there is a large amount of computational power to spare, the color/monochrome designation JT searching unit 22 searches the document database 14 and the color/monochrome designation JT database 16, and determines, in sequence, whether or not each set of document data is associated with the color/monochrome designation JT (S50). Then, the color/monochrome designation JT generation unit 20 analyzes the document data to generate the color/monochrome designation JT (S52), and saves the same in the color/monochrome designation JT database 16 in association with the document data (S54). This process is repeated until determination is made for all the document data (S56).

### Second Exemplary Embodiment

Referring now to FIG. 5 to FIG. 8, a second exemplary embodiment will be described. The second exemplary embodiment corresponds to a modification of the first exemplary embodiment. Therefore, identical elements are represented by the same reference numerals in the drawings, and description thereof is omitted or simplified.

FIG. 5 is a drawing corresponding to FIG. 1, and is a block diagram showing a general configuration of a printing system 50 according to the second exemplary embodiment. The printing system 50 is characterized by the configuration of a document control server 52 and the configuration of a printer 60. In other words, the document control server 52 is provided with a document data sending/receiving unit 54, a color/monochrome designation JT searching unit 56, and a color/monochrome designation JT receiving unit 58 instead of the document data sending/receiving unit 18 in the document control server 12, the color/monochrome designation JT generation unit 20, and the color/monochrome designation JT searching unit 22 shown in FIG. 1. The document data sending/receiving unit 54 saves in the document database 14 the document data received from the client 32 or the like. When the document data saved in the document database 14 are updated, the document data sending/receiving unit 54 deletes the corresponding color/monochrome designation JT from the color/monochrome designation JT database 16. The color/monochrome designation JT searching unit 56 searches for a color/monochrome designation JT corresponding to the document data from the color/monochrome designation JT database 16. Then, the color/monochrome designation JT receiving unit 58 receives the color/monochrome designation JT from the printer 60 and saves the same in the color/monochrome designation JT database 16.

The printer 60 is provided with a color/monochrome designation JT sending unit 62 and a color/monochrome designation JT generation unit 64 in addition to the components of the printer 36 shown in FIG. 1. In the printer 60, the color/monochrome designation JT generation unit 64 analyzes the document data, determines whether each page is to be printed in color or in monochrome, and generates a color/monochrome designation JT in which the result of determination is described prior to an image-developing process of the document data sent from the document control server 52. Then, the color/monochrome designation JT sending unit 62 sends the generated color/monochrome designation JT to the document control server 52.

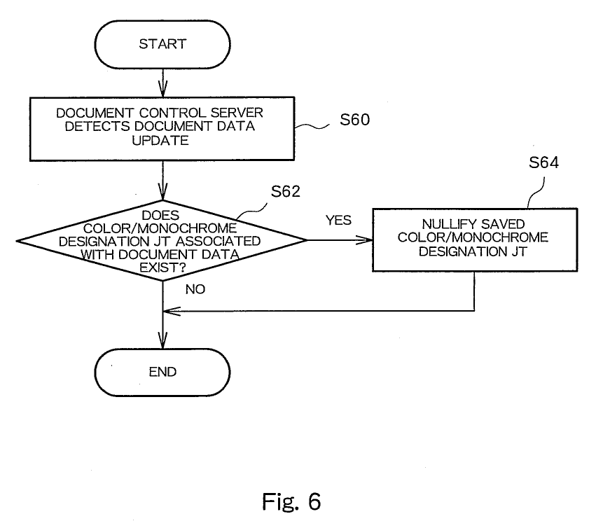

FIG. 6 is an explanatory drawing illustrating the process in a case where the document data saved in the document database 14 of the document control server 52 are updated. When update is detected (S60), the color/monochrome designation JT searching unit 56 searches for the corresponding document data in the color/monochrome designation JT database 16. Then, if the data are saved therein, the document data sending/receiving unit 54 nullifies the saved color/monochrome designation JT (S64).

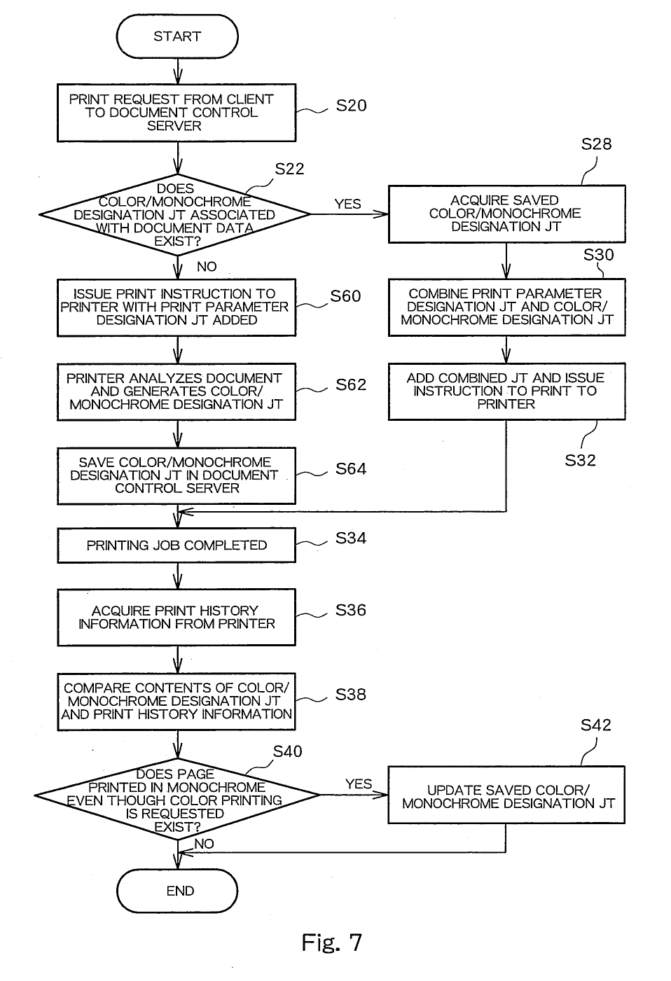

FIG. 7 is a flowchart for explaining a flow of a process in a case where a print request is issued from the client 32 to the document control server 52. In this process, a process in the case where the color/monochrome designation JT does not exist in Step S22 in FIG. 3 is different. In other words, when the color/monochrome designation JT corresponding to the document data relating to the print request does not exist, the document control server 52 generates the JT only on the basis of the print parameter designation JT received from the client 32, and issues a print instruction to the printer 60 (S80). In the printer 60, the color/monochrome designation JT generation unit 64 analyzes the document data, performs a color/monochrome process determination for each page, and generates the color/monochrome designation JT (S82). Subsequently, the color/monochrome designation JT sending unit 62 sends the color/monochrome designation JT to the document control server 52. Then, in the document control server 52, the color/monochrome designation JT receiving unit 58 saves the received color/monochrome designation JT in the color/monochrome designation JT database 16 in association with the document data (S84). The generated color/monochrome designation JT is combined with the JT sent from the document control server in the printer 60, and is used for the printing process in the image-developing unit 38 and the printing unit 40.

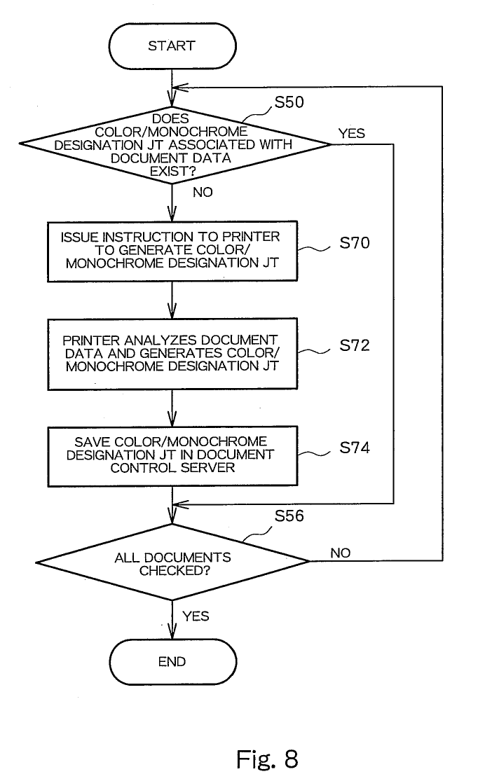

FIG. 8 is a flowchart for explaining an operation performed when there is computational power to spare in the document control server 52. In this case, the color/monochrome designation JT searching unit 56 searches the color/monochrome designation JT database 16 for each set of document data saved in the document database 14, and determines, in sequence, whether or not the respective set of document data is associated with the color/monochrome designation JT (S50). Then, when the color/monochrome designation JT does not exist, the document data are sent to the printer 60, and an instruction to request generation of the color/monochrome designation JT is issued (S70). In the printer 60, the color/monochrome designation JT 64 generates a color/monochrome designation JT on the basis of the analysis of the document data (S72), and the color/monochrome designation JT sending unit 62 sends the color/monochrome designation JT to the document control server 52. In the document control server 52, the color/monochrome designation JT receiving unit 58 saves the received color/monochrome designation JT in the color/monochrome designation JT database 16 (S74).

### Third Exemplary Embodiment

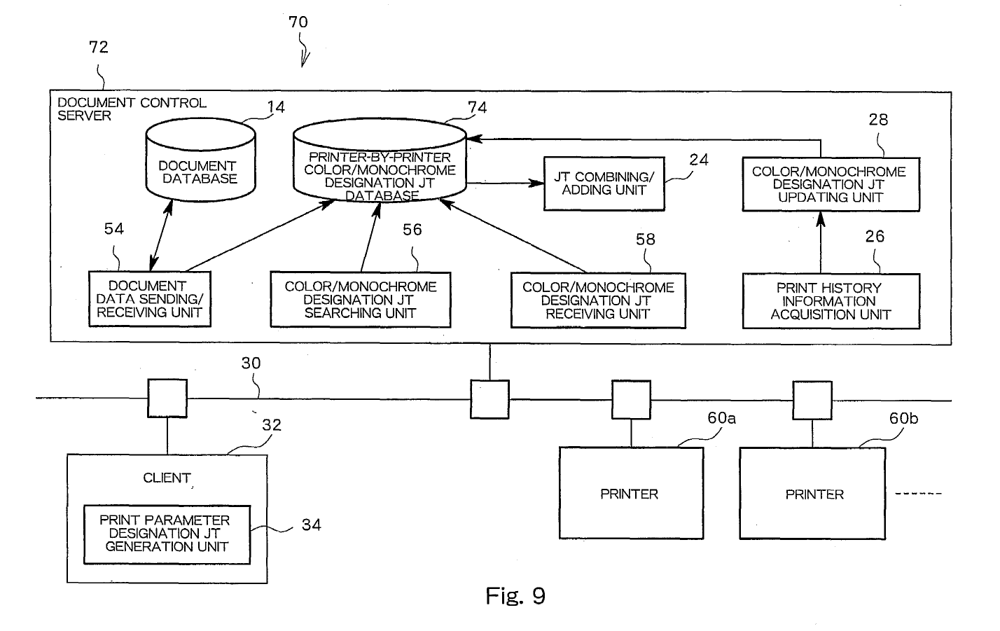

Referring lastly to FIG. 9, a third exemplary embodiment will be described. The third exemplary embodiment is a modification of the second exemplary embodiment, and FIG. 9 is a diagram corresponding to FIG. 5.

A printing system 70 shown in FIG. 9 is characterized in that a printer-by-printer color/monochrome designation JT database 74 is provided in a document control server 72 and multiple printers 60a, 60b, . . . are provided. The respective printers 60a, 60b, . . . are constructed in the same manner as the printer 60 shown in FIG. 5. In other words, in the respective printers 60a, 60b, . . . , the color/monochrome designation JT can be generated on the basis of the received document data. In the printer-by-printer color/monochrome designation JT database 74, color/monochrome designation JTs are saved for the corresponding printers.

In general, in the respective printers 60a, 60b, . . . , a color conversion process and a grayscale process are performed on the basis of the machine-type specific function or setting. Therefore, even though the document data are identical, the threshold for distinguishing the color printing from the monochrome printing differs from printer to printer. Therefore, in the third exemplary embodiment, the color/monochrome designation JTs are generated and saved by printers. When a print request from the client 32 is received, the document control server 72 generates a JT on the basis of the color/monochrome designation JT corresponding to the destination printer, and issues a print instruction to the destination printer.

Subsequently, variations of this exemplary embodiment will be described. In the description, some portions are overlapped with the description given above.

This print control system can be constructed from computer hardware having a computing function and software that specifies the operation thereof. The print control system may be constructed as a centralized data processing system using a single piece of hardware, or as a decentralized data processing system using multiple pieces of hardware in mutual communication. The print control system may be constructed from the same hardware as some of or all the client for issuing the print requests, the printer for performing the printing job, or a storage device for saving the document data or the print set data.

A receiving unit receives a print request relating to the saved document data from the client such as the PC or the multi-function machine. The document data are hard copy data including characters, patterns, or photos, which are generated, for example, by word processor software or spreadsheet software, or by scanning the original sheet. The document data are integrated in the print control system or saved in an external storage device at least before issuance of the print request. The print data as a direct object of the print request may be the saved document data themselves, and may be document data processed by the user, data converted in format, or data converted in resolution. In other words, the print data do not have to be the document data themselves, so long as they are associated with the saved document data.

An acquisition unit acquires the print set data for the document data requested to be printed. The print set data are data stating whether each page of the saved document data are to be printed in color or in monochrome. They may also include detailed setting items stating the type of color printing which is to be performed. The print set data are data saved at least before the print request in association with the document data. The destination of saving may be the same as or different from that of the document data, and may be a storage device integrated in the print control system or an external storage device. Normally, the print setting is stated in the print set data on the basis of the page set in the document data. However, when the printing job is performed with multiple pages or part of a page as a unit, the print setting may be stated by the unit to be printed.

The print instruction unit causes the printer to print the document data on the basis of the print set data. In other words, typically, it causes the printer to perform the printing job in accordance with the print set data. However, it is also possible to cause the printer to print in consideration of user setting at the time of execution and, in this case, a printing job which does not follow the print set data may be generated as a result of adjustment between the two parties.

According to an aspect of the print control system, there is provided a save instruction unit that causes the print set data to be generated and saved when new document data are saved for the first time, or when the document data are updated. When the new document data are saved for the first time or the document data are updated, the print set data corresponding to this electronic document are not normally provided. Therefore, it is configured to generate or save the print set data in advance before issuance of a print request. Generation is typically performed on the basis of analysis of the document data. Examples of the analysis include analysis of meta data in the document data (for example, analyzing whether or not there are color designation data), analysis of the data format (for example, analyzing whether or not the data are data which can support monochrome only), and analysis of real data (for example, analyzing whether or not there actually exists a color portion in the case where the data format is set to color). It is also possible to generate the print set data as specified by the user as a matter of course. The generation and the saving are typically performed by a device that controls the saved document data. However, it is also possible to reform the configuration in order to, for example, cause the printer to generate the document data and the device that controls the saved document data to save as needed. Alternatively, it is also possible to provide a generation and saving unit (and a device that controls the document data as needed) in the print control system and cause these units to perform the generation and saving.

According to another aspect of the print control system, there is provided a save instruction unit that causes print set data to be generated and saved upon receipt of a print request in a case where the print set data saved in association with the document data do not exist. According to this aspect, when the print request is received for the first time, the print set data are generated subsequently. However, from the next time on, the saved print set data can be used. In a case where a print request for the document data which are not saved is given and the document data are to be saved thereafter, the generation and saving of the print set data can be achieved in the same manner.

According to another aspect of the print control system, there is provided a save instruction unit that causes the print set data for the document data having no corresponding print set data saved therein to be generated and saved at a timing determined in consideration of a load applied to a destination of the instruction. In other words, generation and saving of the print set data for the document data which are not yet set are executed when the load applied to the device for generating or saving the print set data is relatively low or is lower than a predetermined threshold.

According to another aspect of the print control system, there is provided a correction instruction unit that causes corresponding print set data to be corrected on the basis of the printed output of the document data. The printed output means an actual document pattern printed on a sheet, or an electronic document pattern to be printed on a sheet. The actual document pattern can be obtained by scanning or from a result of optical inspection. The electronic document pattern can be obtained from final print data generated in the printer, or from data similar to the print data generated by the same procedure by means of a device other than the printer.

According to another aspect of the print control system, the print instruction unit causes the document data to be printed on the basis of a result of combination with print set data specified by the print request. In the printing job, the print setting is specified by the user at the time of execution. Therefore, the saved setting data and the print set data specified by the print request are combined to determine a setting relating to the print instruction. When the two parties have settings which are in conflict with each other, the final setting may be determined on the basis of a predetermined priority.

According to another aspect of the print control system, the print set data are data generated in association with the printer, and the acquisition unit acquires print set data corresponding to the printer to be used for printing. Although the print set data are typically associated with a single printer, they may also be associated with multiple printers from the same manufacturer or of the same machine type. It is also effective to cause standard print set data which do not specify the printer to be acquired when there are no print set data for the printer to be used for printing.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. A print control system comprising:
a receiving unit that receives from a client a print request relating to saved document data;
an acquisition unit that acquires print set data which specify whether respective pages of the document data are to be printed in color or in monochrome; and
a print instruction unit that causes a printer to print the document data on the basis of the print set data;
wherein the print set data are data that are saved in advance in association with the document data.

2. The print control system according to claim 1, further comprising a save instruction unit that causes the print set data to be generated and saved when the document data are saved for the first time, or are updated.

3. The print control system according to claim 1, further comprising a save instruction unit that causes the print set data to be generated and saved upon receipt of the print request in a case where the print set data saved in association with the document data do not exist.

4. The print control system according to claim 1, further comprising a save instruction unit that causes the print set data for the document data having no corresponding print set data saved therein to be generated and saved at a timing determined in consideration of a load applied to a destination of the instruction.

5. The print control system according to claim 1, further comprising a correction instruction unit that causes corresponding print set data to be corrected on the basis of the printed output of the document data.

6. The print control system according to claim 1, wherein the print instruction unit causes the document data to be printed on the basis of a result of combination with print set data specified by the print request.

7. The print control system according to claim 1, wherein the print set data are data generated in association with the printer, and the acquisition unit acquires print set data corresponding to the printer to be used for printing.

8. A print control method comprising:
receiving from a client a print request relating to saved document data;
acquiring print set data which specify whether respective pages of the document data are to be printed in color or in monochrome; and
causing a printer to print the document data on the basis of the print set data;
wherein the print set data are data that are saved in advance in association with the document data.

9. A computer-readable medium storing a program causing a computer to execute a process for print control, the process comprising:
receiving from a client a print request relating to saved document data;
acquiring print set data which specify whether respective pages of the document data are to be printed in color or in monochrome; and
causing a printer to print the document data on the basis of the print set data;
wherein the print set data are data that are saved in advance in association with the document data.

10. A printing system comprising:
a receiving unit that receives from a client a print request relating to saved document data;
an acquisition unit that acquires print set data which specify whether respective pages of the document data are to be printed in color or in monochrome; a printer; and
a print instruction unit that causes the printer to print the document data on the basis of the print set data;
wherein the print set data are data that are saved in advance in association with the document data.

11. The printing system according to claim 10, further comprising a save instruction unit that causes the print set data to be generated and saved when document data are saved for the first time, or the document data are updated.

12. The printing system according to claim 10, further comprising a save instruction unit that causes the print set data to be generated and saved upon receipt of a print request in a case where the print set data saved in association with the document data do not exist.

13. The printing system according to claim 10, further comprising a save instruction unit that causes the print set data for the document data having no corresponding print set data saved therein to be generated and saved at a timing determined in consideration of a load applied to a destination of the instruction.

14. The printing system according to claim 10, further comprising a correction instruction unit that causes corresponding print set data to be corrected on the basis of the printed output of the document data.

15. The printing system according to claim 10, wherein the print instruction unit causes the document data to be printed on the basis of a result of combination with print set data specified by the print request.

16. The printing system according to claim 10, wherein the print set data are data generated in association with the printer, and the acquisition unit acquires print set data corresponding to the printer to be used for printing.
